(19) United States
(12) Patent Application Publication
(10) Pub. No.: US 2018/0254854 A1
(43) Pub. Date: Sep. 6, 2018

(54) COMMUNICATIONS SYSTEM AND COMMUNICATION METHOD FOR COMMUNICATIONS SYSTEM

(71) Applicant: FANUC CORPORATION, Yamanashi (JP)

(72) Inventor: Kunitaka Komaki, Minamitsuru-gun (JP)

(73) Assignee: FANUC CORPORATION, Yamanashi (JP)

(21) Appl. No.: 15/910,358

(22) Filed: Mar. 2, 2018

(30) Foreign Application Priority Data
Mar. 3, 2017 (JP) 2017-040310

(51) Int. Cl. H04L 1/00

(52) U.S. Cl. CPC H04L 1/0042; H04L 1/0061

(57) ABSTRACT

A communications system includes a computer numerical control device, which is hereinafter referred to as a CNC, and amplifiers connected to the CNC by a serial communications circuit, and in the communications system, packets are transmitted from the CNC to the amplifiers at each of predetermined periods. Each of the packets contains at least data and an error detection code. The CNC calculates an allowable number of transmissions at which the packets can be transmitted within the predetermined period, and transmits the same packet a plurality of times within the allowable number of transmissions. The amplifiers check the error detection codes of the received packets, and acquire data of the packets for which no errors are detected.

### CROSS-REFERENCE TO RELATED APPLICATION

This application is based upon and claims the benefit of priority from Japanese Patent Application No. 2017-040310 filed on Mar. 3, 2017, the contents of which are incorporated herein by reference.

### BACKGROUND OF THE INVENTION

### Field of the Invention

The present invention relates to a communications system and a communication method for a communications system.

### Description of the Related Art

Japanese Laid-Open Patent Publication No. 08-116331 discloses that when a terminal device is incapable of normally receiving packets transmitted by a master device, the terminal device transmits a negative response to the master device, and when the negative response is received by the master device, the packets are retransmitted from the master device to the terminal device.

### SUMMARY OF THE INVENTION

With the technique disclosed in Japanese Laid-Open Patent Publication No. 08-116331, since the master device (transmitting node) retransmits the packets to the terminal device (receiving node) after having waited to receive the negative response, there is a concern that time will be required until the packets can be received normally at the receiving node.

The present invention has been devised in order to solve the aforementioned problem, and has the object of providing a communications system and a communication method for a communications system, which are capable of preventing a delay in reception of packets while the packets are received normally at a receiving node.

A first aspect of the present invention is characterized by a communications system including a transmitting node, and a receiving node connected by a communications circuit to the transmitting node, the communications system being configured to transmit packets from the transmitting node to the receiving node at each of predetermined periods, wherein each of the packets contains at least data and an error detection code, the transmitting node calculates an allowable number of transmissions at which the packets can be transmitted within the predetermined period, and transmits the same packets a plurality of times within the allowable number of transmissions, and the receiving node checks the error detection codes of the received packets, and acquires data of the packets for which no errors are detected.

A second aspect of the present invention is characterized by a communication method for a communications system including a transmitting node, and a receiving node connected by a communications circuit to the transmitting node, the communications system being configured to transmit packets from the transmitting node to the receiving node at each of predetermined periods, wherein each of the packets contains at least data and an error detection code, the communication method including an allowable number of transmissions calculating step of calculating, in the transmitting node, an allowable number of transmissions at which the packets can be transmitted within the predetermined period, a packet transmitting step of transmitting, in the transmitting node, the same packets a plurality of times within the allowable number of transmissions, a packet receiving step of receiving, in the receiving node, the packets transmitted from the transmitting node, an error detection code checking step of checking, in the receiving node, the error detection codes of the received packets, and a data acquisition step of acquiring, in the receiving node, data of the packets for which no errors are detected.

According to the present invention, while packets are received normally at the receiving node, a delay in reception of the packets can be prevented.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a diagram showing a configuration of a communications system according to a first embodiment of the present invention;

FIG. 2 is a time chart showing a transmission timing of packets transmitted from a CNC according to the first embodiment;

FIG. 3 is a block diagram showing a configuration of the CNC according to the first embodiment;

FIG. 4 is a flowchart showing a control flow of a packet transmission process performed in a transmission/reception circuit according to the first embodiment;

FIG. 5 is a diagram showing an example of a packet according to the first embodiment;

FIG. 6 is a diagram showing the configuration of an amplifier according to the first embodiment;

FIG. 7 is a flowchart showing a control flow of a packet reception process performed in the transmission/reception circuit according to the first embodiment;

FIG. 8 is a time chart showing a transmission timing of packets transmitted from a conventional CNC;

FIG. 9 is a diagram showing the configuration of a communications system according to a second embodiment;

FIG. 10 is a time chart showing a transmission timing of packets transmitted from a CNC according to the second embodiment;

FIG. 11 is a flowchart showing a control flow of a packet transmission process performed in the transmission/reception circuit according to the second embodiment;

FIG. 12 is a flowchart showing a control flow of a packet reception process performed in the transmission/reception circuit according to the second embodiment; FIG. 13 is a diagram showing the configuration of a communications system according to a third embodiment;

FIG. 14 is a time chart showing a transmission timing of packets transmitted from a CNC according to the third embodiment;

FIG. 15 is a flowchart showing a control flow of a packet transmission process performed in the transmission/reception circuit according to the third embodiment;

FIG. 16 is a diagram showing the configuration of an amplifier according to the third embodiment; and

FIG. 17 is a flowchart showing a control flow of a packet reception process performed in the transmission/reception circuit according to the third embodiment.

### DESCRIPTION OF THE PREFERRED EMBODIMENTS

The present invention will be described below through various embodiments of the present invention. The illustrative embodiments are not intended to limit the present invention as defined in the appended claims.

Furthermore, all of the combinations of features discussed in the illustrative embodiments might not be absolutely necessary for achieving the inventive solution.

### First Embodiment

### [Concerning the Communications System]

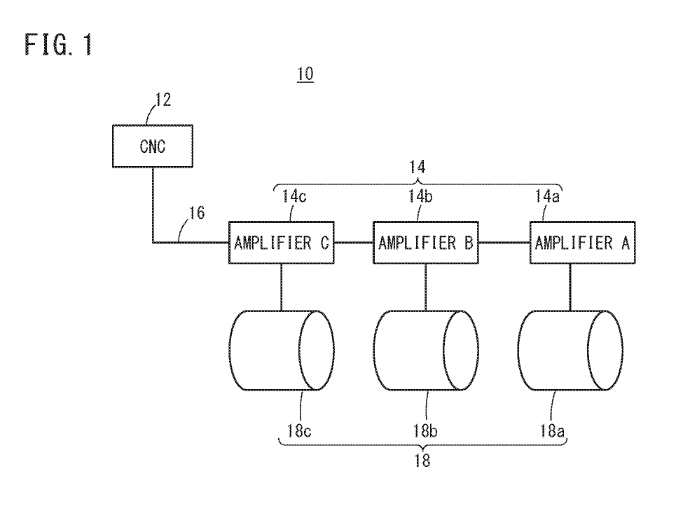

FIG. 1 is a diagram showing a configuration of a communications system 10 according to a first embodiment. The communications system 10 includes a computer numerical control device (hereinafter referred to as a CNC) (transmitting node) 12, an amplifier A 14a, an amplifier B 14b, and an amplifier C 14c. Hereinafter, unless distinguished specifically from each other, the amplifier A 14a, the amplifier B 14b, and the amplifier C 14c will be referred to collectively as amplifiers (receiving nodes) 14. The CNC 12, the amplifier A 14a, the amplifier B 14b, and the amplifier C 14c are connected in a daisy chain fashion by a serial communications circuit 16. The amplifiers 14 are connected to the serial communications circuit 16 in order of the amplifier A 14a, the amplifier B 14b, and the amplifier C 14c in a farthest ordering from the CNC 12, i.e., with the amplifier A 14a being farthest from the CNC 12.

The CNC 12 is a control device adapted to control a machine tool, an industrial machine, or the like. The amplifiers 14 are servo amplifiers that control the electric power supplied to servomotors of machine tools, industrial machines, etc., in accordance with motor command values transmitted from the CNC 12. The amplifier A 14a, the amplifier B 14b, and the amplifier C 14c control the electric power to be supplied respectively to a servomotor A 18a, a servomotor B 18b, and a servomotor C 18c. Hereinafter, unless distinguished specifically from each other, the servomotor A 18a, the servomotor B 18b, and the servomotor C 18c will be referred to collectively as servomotors 18.

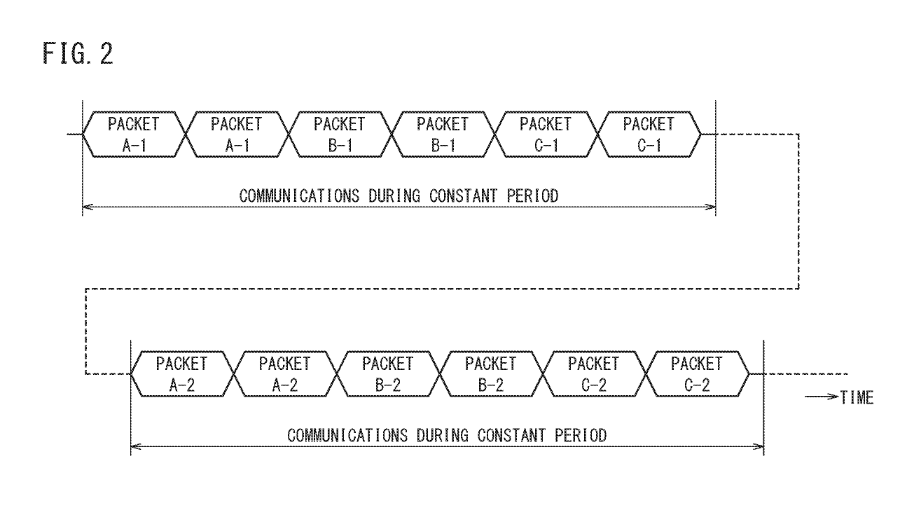

In the communications system 10 according to the present embodiment, packets including motor command values and the like are transmitted from the CNC 12 to each of the amplifier A 14a, the amplifier B 14b, and the amplifier C 14c via the serial communications circuit 16. FIG. 2 is a time chart showing a transmission timing of packets transmitted from the CNC 12. For example, the designations “Packet A-1” and “Packet A-2” in FIG. 2 indicate that the destination of the packets is the amplifier A 14a, however, the content of the packets differ from each other. On the other hand, the designations “Packet A-1” and “Packet A-1” in FIG. 2 indicate that the destination of the packets is the amplifier A 14a, and that they are the same packet having the same packet content as well.

The CNC 12 transmits packets to each of the amplifier A 14a, the amplifier B 14b, and the amplifier C 14c at each of regular predetermined periods. Since the packets include the motor command values as described above, and the values of the motor command values vary over time, the contents of the packets transmitted in each of the periods also differ.

For example, in the example shown in FIG. 2, within the same period, the CNC 12 transmits the same packet twice to the same amplifiers 14. The communications system 10 according to the present embodiment increases the redundancy of communication data as well as improving the reliability of communications by transmitting the same packet a plurality of times within the same period from the CNC 12 to each of the amplifiers 14.

### [Concerning the CNC]

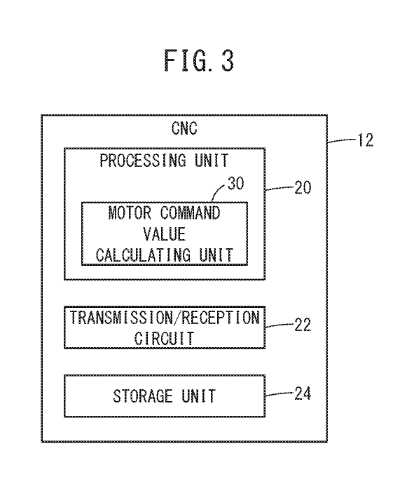

FIG. 3 is a block diagram showing a configuration of the CNC 12. The CNC 12 comprises a processing unit 20, a transmission/reception circuit 22, and a storage unit 24. The processing unit 20 is constituted by a processor, a memory, and the like, and further is equipped with a motor command value calculating unit 30. The motor command value calculating unit 30 reads out an NC program that is stored in the storage unit 24, executes the NC program, and calculates motor command values for controlling the servomotors 18.

The transmission/reception circuit 22 is constituted by a processor, a memory, and the like, and performs a communication process via the serial communications circuit 16. More specifically, the transmission/reception circuit 22 generates packets including data such as motor command values and the like designated by the processing unit 20 in accordance with a predetermined communications protocol, and performs a transmission process to cause the generated packets to flow to the serial communications circuit 16. Further, the transmission/reception circuit 22 performs a reception process of extracting data from the packets received via the serial communications circuit 16, and transmitting the data to the processing unit 20. The storage unit 24 is a semiconductor memory or the like, and stores an NC program and the like which is executed in the processing unit 20.

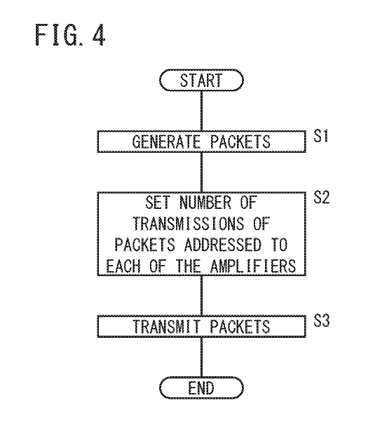

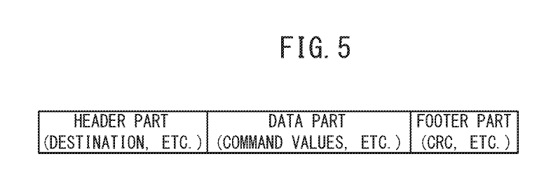

FIG. 4 is a flowchart showing a control flow of a packet transmission process performed in a transmission/reception circuit 22. In step S1, packets are generated in accordance with a predetermined communications protocol. FIG. 5 is a diagram showing an example of a packet. As shown in FIG. 5, the packet includes a header part, a data part, and a footer part. In the header part, identification information, etc., of one of the amplifiers 14, which is the destination to which the packet is to be transmitted, is stored. In the data part, the motor command values and the like are stored. In the footer part, a CRC or the like is stored, which is an error detection code for detecting whether or not the packet contains a code error.

In step S2, the number of transmissions of packets addressed to each of the amplifiers 14 is set. The transmission/reception circuit 22 calculates an allowable number of transmissions at which the packets can be transmitted within one period. In the example shown in FIG. 2, the CNC 12 is capable of transmitting packets six times in one period. The number of packets that are capable of being transmitted in one period is calculated from the length of the one period, the capacity of one packet, the transmission clock pulse, and the like. Furthermore, the transmission/reception circuit 22 allocates the number of transmissions of packets addressed to each of the amplifiers 14 within the allowable number of transmissions. In the example shown in FIG. 2, the number of transmissions of packets addressed to each of the amplifiers 14 is set to two times.

Moreover, for example, when the allowable number of transmissions of packets is seven, and the number of transmissions of packets addressed to each of the amplifiers 14 cannot be set to the same number of times, then the number of transmissions of packets addressed to each of the amplifiers 14 may be set appropriately, for example, the number of transmissions of packets addressed to the amplifier A 14a connected at the farthest position from the CNC 12 may be set to three times, and the number of transmissions of packets addressed to each of the amplifier B 14b and the amplifier C 14c may be set to two times, or the like.

In step S3, the packets are transmitted in the order of the packets addressed to the amplifier A 14a, the packets addressed to the amplifier B 14b, and the packets addressed to the amplifier C 14c. The processes of the aforementioned steps S1 to S3 are performed at each of regular predetermined intervals.

### [Concerning the Amplifiers]

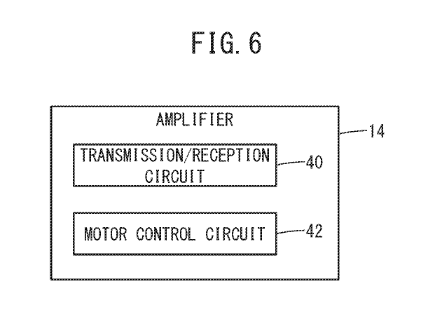

FIG. 6 is a diagram showing the configuration of one of the amplifiers 14. The configuration of the amplifiers 14 is common to the amplifier A 14a, the amplifier B 14b, and the amplifier C 14c. Each of the amplifiers 14 includes a transmission/reception circuit 40, and a motor control circuit 42.

The transmission/reception circuit 40 is constituted by a processor, a memory, and the like, and performs a communication process via the serial communications circuit 16. More specifically, the transmission/reception circuit 40 generates packets including data in accordance with a predetermined communications protocol, and performs a transmission process to cause the generated packets to flow to the serial communications circuit 16. Further, the transmission/reception circuit 40 performs a reception process of extracting data from the packets received via the serial communications circuit 16, and transmitting the data to the motor control circuit 42. The motor control circuits 42 supply electric power to the servomotors 18 based on the motor command values transmitted thereto from the transmission/reception circuits 40.

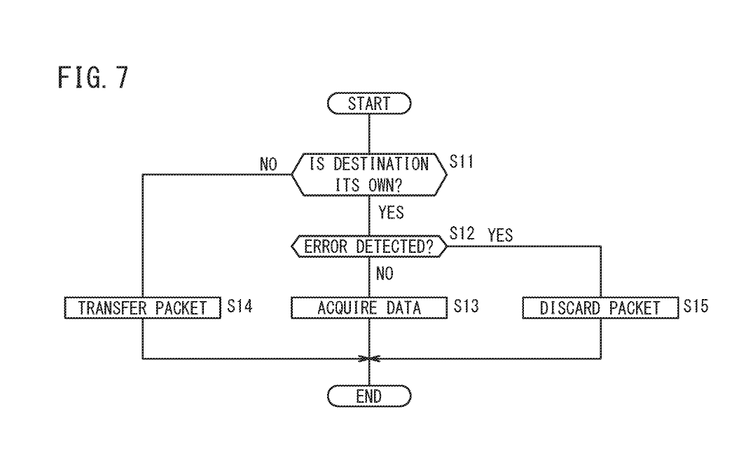

FIG. 7 is a flowchart showing a control flow of a packet reception process performed in the transmission/reception circuits 40. In step S11, the destination of the header part of the received packet is confirmed, and it is determined whether or not the destination of the packet is its own (i.e., is the destination of itself). If the destination is its own, the process proceeds to step S12, and if the destination is other than its own, the process proceeds to step S14.

In step S12, the error detection code of the footer part of the received packet is confirmed, and it is determined whether a code error of the packet has been detected. If a code error is detected, the process proceeds to step S15, and if a code error is not detected, the process proceeds to step S13.

In step S13, data such as motor command values are acquired from the data part of the packet, and the acquired data is transmitted to the motor control circuits 42. Following step S11, in step S14, the received packet is passed through without modification, and the packet is transferred to another one of the amplifiers 14. Following step S12, in step S15, the received packet is discarded.

### [Operations and Effects]

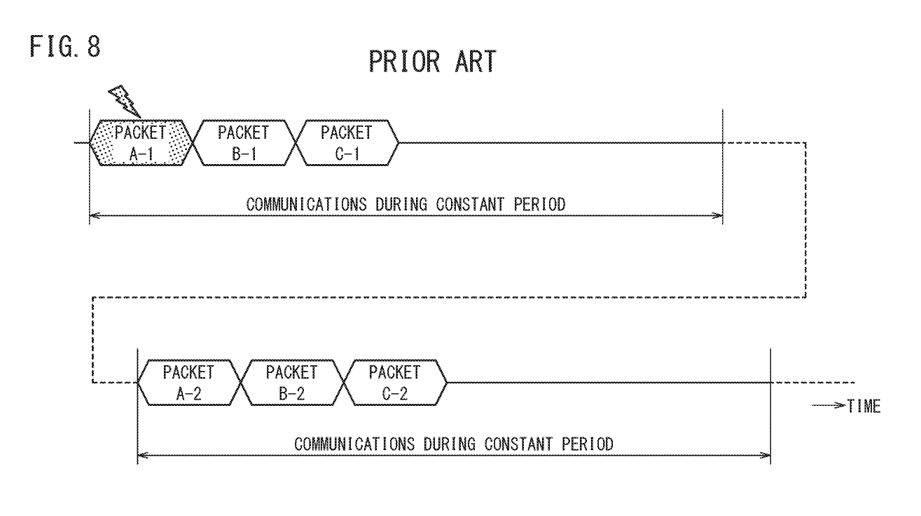

FIG. 8 is a time chart showing a transmission timing of packets transmitted from a conventional CNC 12. In the example shown in FIG. 8, packets are transmitted one time to each of the amplifier A 14a, the amplifier B 14b, and the amplifier C 14c during each of the regular predetermined intervals.

For example, in the case that a code error has occurred in “packet A-1” during the period that the “packet A-1” is transmitted to the amplifier A 14a via the serial communications circuit 16, the amplifier A 14a discards the “packet A-1”. Therefore, a missing portion will occur in the data to be received by the amplifier A 14a. In the event that a missing portion occurs in the data, then in the amplifier A 14a, a process such as one to complete the data missing from the data received before and after the missing portion is performed, however, in this case, there is a concern that the control accuracy of the servomotor 18a will be deteriorated. Further, depending on the content of the missing data, there may be a need for the amplifiers 14 to stop driving the servomotors 18 and to transmit an abnormality occurrence signal to the CNC 12, whereupon the CNC 12 controls a non-illustrated notification unit, whereby a notification is issued to the operator to the effect that such an abnormality has occurred.

In the case that a code error has occurred in “Packet A-1”, although it might be considered to transmit an error detection signal from the amplifier A 14a to the CNC 12, and for the “packet A-1” to be retransmitted from the CNC 12, even if the packet is retransmitted in this manner, the control of the servomotor 18a is delayed, and deterioration in the control accuracy of the servomotor 18a cannot be avoided.

Thus, according to the present embodiment, in the CNC 12, the allowable number of transmissions that packets can be transmitted within the regular predetermined period during which packets are transmitted is calculated, and the same packets are transmitted a plurality of times with respect to each of the amplifiers 14 within the allowable number of transmissions. Owing to this feature, redundancy of the communication data of the serial communications circuit 16 can be enhanced, the reliability of communications can be improved, and a delay in communications can be prevented.

### Second Embodiment

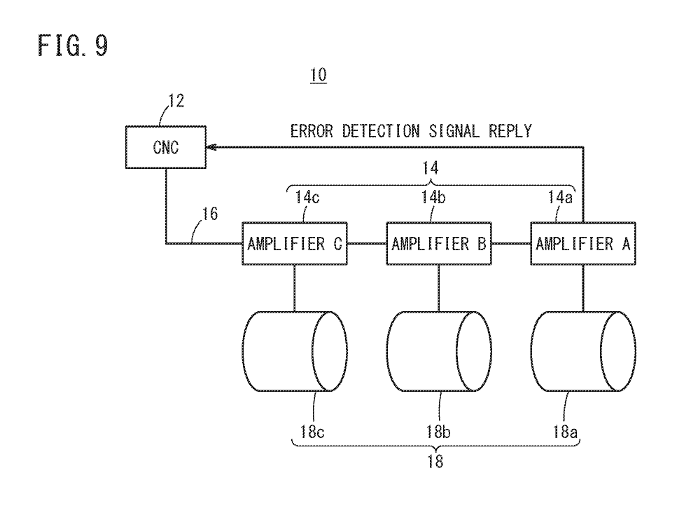

FIG. 9 is a diagram showing the configuration of a communications system 10 according to a second embodiment. Similar to the communications system 10 according to the first embodiment, the communications system 10 includes a computer numerical control device (CNC) 12, an amplifier A 14a, an amplifier B 14b, and an amplifier C 14c. The CNC 12, the amplifier A 14a, the amplifier B 14b, and the amplifier C 14c are connected by the serial communications circuit 16. The amplifiers 14 are connected to the serial communications circuit 16 in order of the amplifier A 14a, the amplifier B 14b, and the amplifier C 14c in a farthest ordering from the CNC 12, i.e., with the amplifier A 14a being farthest from the CNC 12.

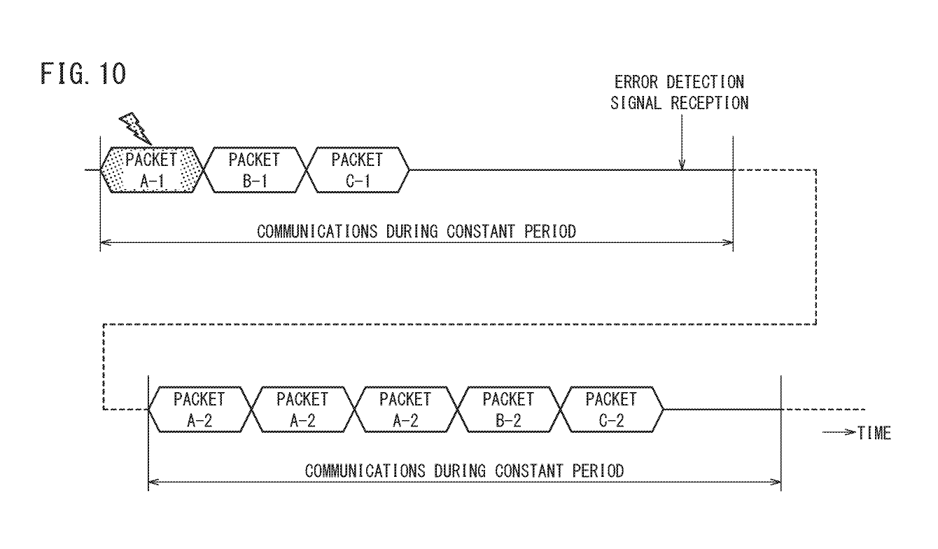

FIG. 10 is a time chart showing a transmission timing of packets transmitted from the CNC 12. In the communications system 10 according to the present embodiment, packets including motor command values and the like are transmitted from the CNC 12 to each of the amplifier A 14a, the amplifier B 14b, and the amplifier C 14c via the serial communications circuit 16. Differing from the first embodiment, initially, packets are transmitted one time from the CNC 12 to each of the amplifiers 14 within the same period. For example, it is assumed that the “packet A-1” addressed to the amplifier A 14a includes a code error. In this case, an error detection signal indicating that a code error has been included in the “packet A-1” received by the amplifier A 14a is transmitted in reply to the CNC 12 from the amplifier A 14a. During a period after the time when the error detection signal was received, regarding the packet addressed to the amplifier A 14a that has replied with the error detection signal, the CNC 12 transmits the same packet a plurality of times within the same period. In the communications system 10 according to the present embodiment, the CNC 12 transmits the same packet, which is addressed to the amplifier 14 that has replied with the error detection signal, a plurality of times within the same period, whereby the reliability of communications is improved.

### [Configuration of CNC]

Although the configuration per se of the CNC 12 is the same as in the first embodiment, the transmission process performed in the transmission/reception circuit 22 differs from that of the first embodiment.

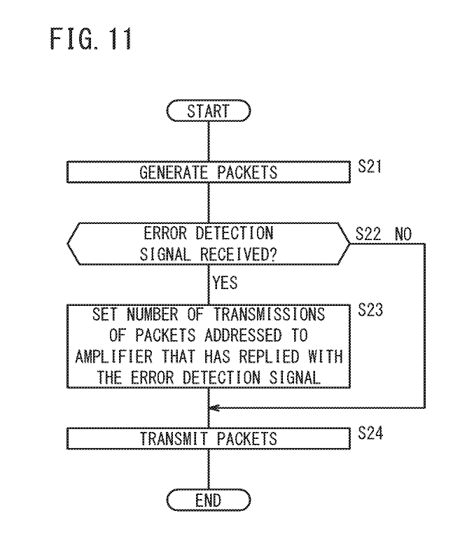

FIG. 11 is a flowchart showing a control flow of a packet transmission process performed in the transmission/reception circuit 22. In step S21, packets are generated in accordance with a predetermined communications protocol. In step S22, it is determined whether or not an error detection signal from the amplifiers 14 has been received. If an error detection signal is received, the process proceeds to step S23. If an error detection signal is not received, the process proceeds to step S24.

In step S23, the number of transmissions of packets addressed to the amplifiers 14 that have replied with the error detection signal is set. The transmission/reception circuit 22 calculates an allowable number of transmissions at which the packets can be transmitted within one period. In the example shown in FIG. 10, the CNC 12 is capable of transmitting packets six times in one period. The number of packets that are capable of being transmitted in one period is calculated from the length of the one period, the capacity of one packet, the transmission clock pulse, and the like. Furthermore, the transmission/reception circuit 22 sets the number of transmissions of packets addressed to the amplifiers 14 that have replied with the error detection signal, in a range in which the total number of transmissions of packets addressed to the respective amplifiers 14 lies within the allowable number of transmissions in one period. In the example of FIG. 10, the number of times of transmission of the packets addressed to the amplifier 14a is set to three times in the period after the CNC 12 has received the error detection signal from the amplifier 14a. Moreover, the number of transmissions of the packets addressed to the amplifier 14 that has replied with the error detection signal may be set appropriately to a value of two times or more.

In step S24, the packets are transmitted in the order of the packets addressed to the amplifier A 14a, the packets addressed to the amplifier B 14b, and the packets addressed to the amplifier C 14c. In the example of FIG. 10, the packet addressed to the amplifier A 14a is transmitted three times, and the packets addressed to the amplifier B 14b and the amplifier C 14c are transmitted one time each. The processes of the aforementioned steps S21 to S24 are performed at each of regular predetermined intervals.

### [Concerning the Amplifiers]

The configuration per se of the amplifiers 14 is the same as in the first embodiment, however, the reception process performed in the transmission/reception circuits 40 differs from that of the first embodiment.

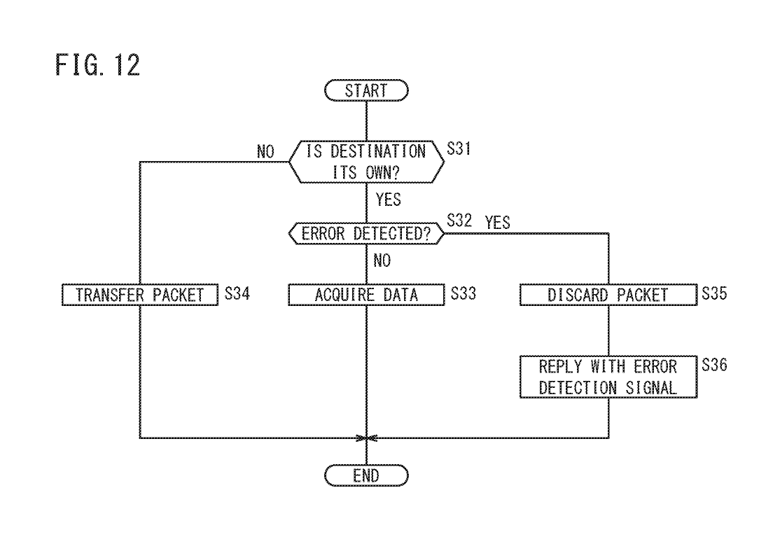

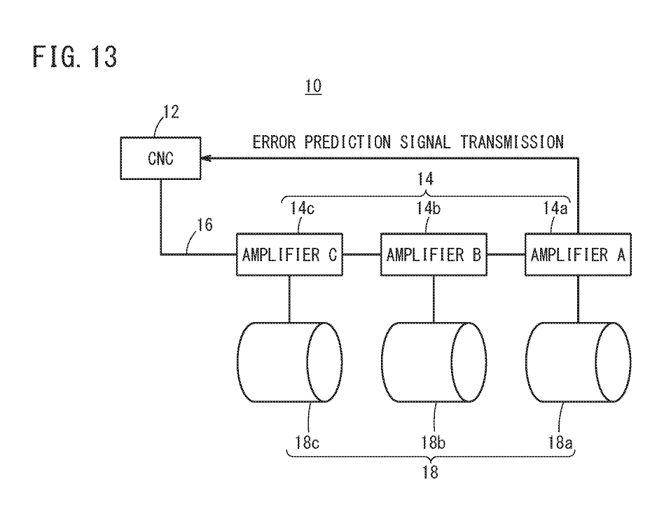

FIG. 12 is a flowchart showing a control flow of a packet reception process performed in the transmission/reception circuits 40. In step S31, the destination of the header part of the received packet is confirmed, and it is determined whether or not the destination of the packet is its own (i.e., is the destination of itself). If the destination is its own, the process proceeds to step S32, and if the destination is other than its own, the process proceeds to step S34.

In step S32, the error detection code of the footer part of the received packet is confirmed, and it is determined whether a code error of the packet has been detected. If a code error is detected, the process proceeds to step S35, and if a code error is not detected, the process proceeds to step S33.

In step S33, data such as motor command values are acquired from the data part of the packet, and the acquired data is transmitted to the motor control circuits 42. In step S34, the received packet is passed through without modification, and the packet is transferred to another one of the amplifiers 14. In step S35, the received packet is discarded. In step S36, an error detection signal is transmitted in reply to the CNC 12.

### [Operations and Effects]

According to the present embodiment, when the CNC 12 has received an error detection signal from an amplifier 14, the CNC 12 transmits the same packet to the amplifier 14 that has replied with the error detection signal a plurality of times within the same period. Since code errors for the packets are frequently generated in the serial communications circuit 16, code errors tend to occur in a packet of the same destination as the packet containing code errors. By transmitting only packets of the same destination as packets including code errors in the past, a plurality of times, it becomes possible to increase, within one period, the number of times that packets are transmitted for destinations which are likely to have code errors occurring therein. Owing to this feature, the reliability and stability of communications of the serial communications circuit 16 can be enhanced.

Furthermore, because the CNC 12 increases only the number of transmissions of packets addressed to amplifiers 14 that have replied with the error detection signal, the number of packets transmitted by the CNC 12 can be reduced as a whole. Owing to this feature, congestion of communications in the serial communications circuit 16 can be suppressed.

### Third Embodiment

FIG. 13 is a diagram showing the configuration of a communications system 10 according to a third embodiment. Similar to the communications system 10 according to the first embodiment, the communications system 10 includes a computer numerical control device (CNC) 12, an amplifier A 14a, an amplifier B 14b, and an amplifier C 14c. The CNC 12, the amplifier A 14a, the amplifier B 14b, and the amplifier C 14c are connected by the serial communications circuit 16. The amplifiers 14 are connected to the serial communications circuit 16 in order of the amplifier A 14a, the amplifier B 14b, and the amplifier C 14c in a farthest ordering from the CNC 12, i.e., with the amplifier A 14a being farthest from the CNC 12.

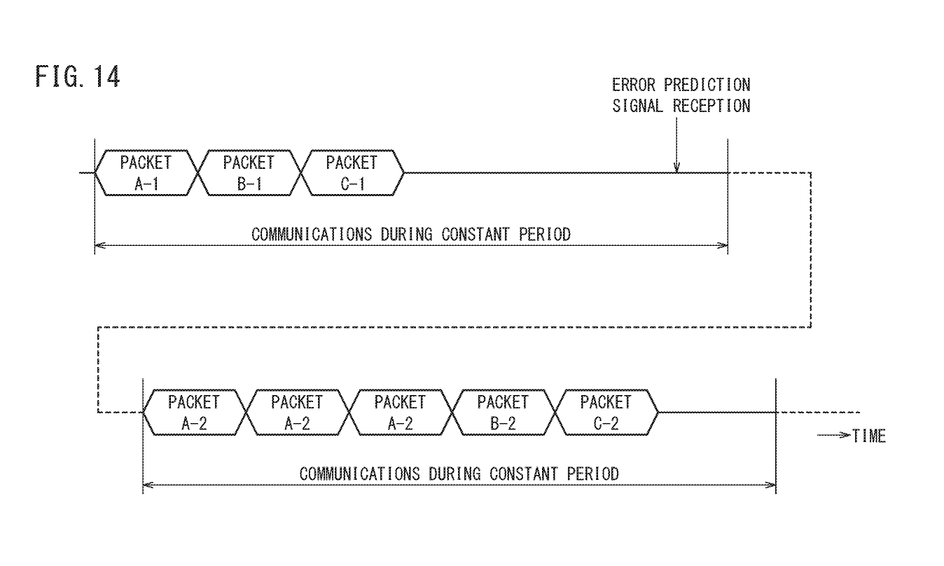

FIG. 14 is a time chart showing a transmission timing of packets transmitted from the CNC 12. In the communications system 10 according to the present embodiment, packets including motor command values and the like are transmitted from the CNC 12 respectively to each of the amplifier A 14a, the amplifier B 14b, and the amplifier C 14c via the serial communications circuit 16. Differing from the first embodiment, initially, packets are transmitted one time from the CNC 12 to each of the amplifiers 14 within the same period. For example, it is assumed that the amplitude of the signal at the time that the amplifier A 14a receives the “packet A-1” is less than or equal to a predetermined value. In this case, even if the “packet A-1” received by the amplifier A 14a does not include a code error therein, there is a high possibility that a code error will be included in the packets received thereafter. In this case, an error prediction signal, which indicates that there is a high possibility that a packet code error will occur, is transmitted from the amplifier A 14a to the CNC 12. During a period after the time when the error prediction signal was received, regarding the packet addressed to the amplifier A 14a that has transmitted the error prediction signal, the CNC 12 transmits the same packet a plurality of times within the same period. In the communications system 10 according to the present embodiment, the CNC 12 transmits the same packet, which is addressed to the amplifier 14 that has transmitted the error prediction signal, a plurality of times within the same period, whereby the reliability of communications is improved.

### [Concerning the CNC]

Although the configuration per se of the CNC 12 is the same as in the first embodiment, the transmission process performed in the transmission/reception circuit 22 differs from that of the first embodiment.

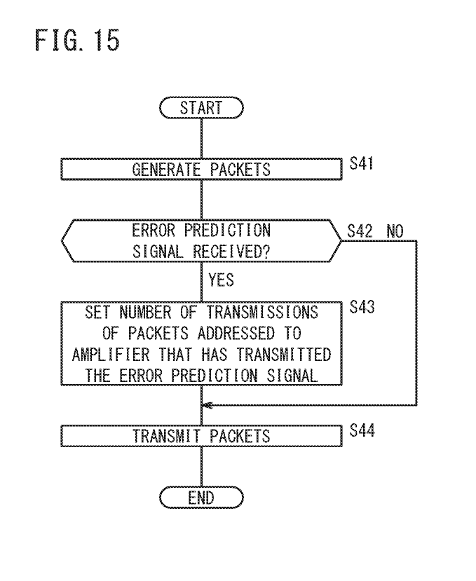

FIG. 15 is a flowchart showing a control flow of a packet transmission process performed in the transmission/reception circuit 22. In step S41, packets are generated in accordance with a predetermined communications protocol. In step S42, it is determined whether or not an error prediction signal from the amplifiers 14 has been received. If an error prediction signal is received, the process proceeds to step S43. If an error prediction signal is not received, the process proceeds to step S44.

In step S43, the number of transmissions of packets addressed to the amplifiers 14 that have transmitted the error prediction signal is set. The transmission/reception circuit 22 calculates an allowable number of transmissions at which the packets can be transmitted within one period. In the example shown in FIG. 14, the CNC 12 is capable of transmitting packets six times in one period. An allowable number of transmissions of packets that are capable of being transmitted in one period is calculated from the length of the one period, the capacity of one packet, the transmission clock pulse, and the like. Furthermore, the transmission/reception circuit 22 sets the number of transmissions of packets addressed to the amplifiers 14 that have transmitted the error prediction signal, in a range in which the total number of transmissions of packets addressed to the respective amplifiers 14 lies within the allowable number of transmissions in one period. In the example of FIG. 14, the number of times of transmission of the packets addressed to the amplifier 14a is set to three times in the period after the CNC 12 has received the error prediction signal from the amplifier 14a. Moreover, the number of transmissions of the packets addressed to the amplifier 14 that has transmitted the error prediction signal may be set appropriately to a value of two times or more.

In step S44, the packets are transmitted in the order of the packets addressed to the amplifier A 14a, the packets addressed to the amplifier B 14b, and the packets addressed to the amplifier C 14c. In the example of FIG. 14, the packet addressed to the amplifier A 14a is transmitted three times, and the packets addressed to the amplifier B 14b and the amplifier C 14c are transmitted one time each. The processes of the aforementioned steps S41 to S44 are performed at each of regular predetermined intervals.

### [Concerning the Amplifiers]

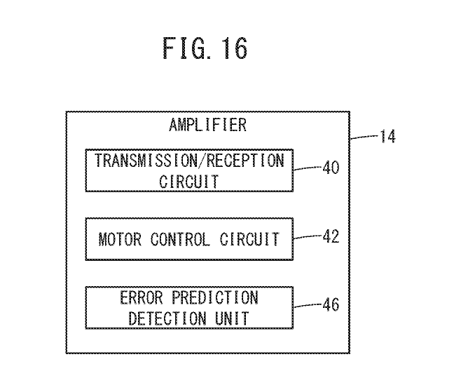

FIG. 16 is a diagram showing the configuration of one of the amplifiers 14. In the amplifiers 14 of the present embodiment, an error prediction detection unit 46 is added to each of the amplifiers 14 of the first embodiment (see FIG. 6).

The error prediction detection unit 46 detects a situation in which there is a concern that a code error may be included in packets received by the amplifiers 14. More specifically, the error prediction detection unit 46 detects whether or not there is an indication (hereinafter referred to as an error prediction) that the magnitude of an amplitude of the signal received by the amplifiers 14 is less than or equal to a predetermined amplitude, that an amplitude of noise within the amplifiers 14 is greater than or equal to a predetermined amplitude, that a temperature within the amplifiers 14 is greater than or equal to a predetermined temperature, or that a vibration of the amplifiers 14 is greater than or equal to a predetermined amplitude. When an error prediction is detected, the error prediction detection unit 46 commands the transmission/reception circuits 40 to transmit an error prediction signal to the CNC 12.

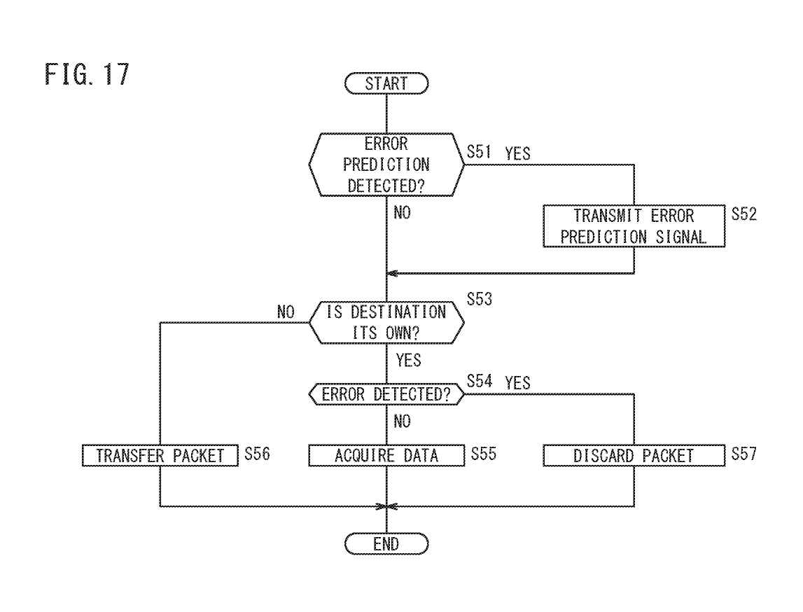

FIG. 17 is a flowchart showing a control flow of a packet reception process performed in the transmission/reception circuits 40. In step S51, the error prediction detection unit 46 determines whether or not an error prediction has been detected. If an error prediction is detected, the process proceeds to step S52, and if an error prediction is not detected, the process proceeds to step S53. In step S52, an error prediction signal is transmitted to the CNC 12.

In step S53, the destination of the header part of the received packet is confirmed, and it is determined whether or not the destination of the packet is its own (i.e., is the destination of itself). If the destination is its own, the process proceeds to step S54, and if the destination is other than its own, the process proceeds to step S56.

In step S54, the error detection code of the footer part of the received packet is confirmed, and it is determined whether a code error of the packet has been detected. If a code error is detected, the process proceeds to step S57, and if a code error is not detected, the process proceeds to step S55.

In step S55, data such as motor command values are acquired from the data part of the packet, and the acquired data is transmitted to the motor control circuits 42. In step S56, the received packet is passed through without modification, and the packet is transferred to another one of the amplifiers 14. In step S57, the received packet is discarded.

### [Operations and Effects]

According to the present embodiment, when the CNC 12 has received an error prediction signal from the amplifiers 14, the CNC 12 transmits the same packets to the amplifiers 14 that have transmitted the error prediction signal, a plurality of times within the same period. There is a tendency for code errors to occur in the packets received by the amplifiers 14 that have detected the error prediction. By transmitting only those packets, which are addressed to amplifiers 14 that have detected the error prediction, a plurality of times, it becomes possible to increase within one period the number of times that packets are transmitted for destinations which are likely to have code errors occurring therein. Further, the packets can be transmitted a plurality of times prior to a code error occurring in the packets. Owing to this feature, the reliability and stability of communications of the serial communications circuit 16 can be enhanced.

Furthermore, because the CNC 12 increases only the number of transmissions of packets addressed to amplifiers 14 that have transmitted the error prediction signal, the number of packets transmitted by the CNC 12 can be reduced as a whole. Owing to this feature, congestion of communications in the serial communications circuit 16 can be suppressed.

### Other Embodiments

Although the present invention has been described with reference to particular embodiments, the technical scope of the present invention is not limited to the scope defined by the above embodiments. It goes without saying that various modifications or improvements are capable of being added to the above embodiments. It is clear from the scope of the claims that other modes to which such modifications or improvements have been added can be included within the technical scope of the present invention.

According to the above embodiments, a method of setting the number of transmissions of packets to be transmitted from the CNC 12 to the amplifiers 14 has been described. However, the number of transmissions may also be set for packets to be transmitted from the amplifiers 14 to the CNC 12, or from one amplifier 14 to another amplifier 14.

### Technical Concept Obtained from the Embodiments

The technical concept that can be grasped from the above embodiments will be described below.

The communications system (10) includes a transmitting node (12), and a receiving node (14) connected by a communications circuit to the transmitting node (12), the communications system (10) being configured to transmit packets from the transmitting node (12) to the receiving node (14) at each of predetermined periods, wherein each of the packets comprises at least data and an error detection code, the transmitting node (12) calculates an allowable number of transmissions at which the packets can be transmitted within the predetermined period, and transmits the same packets a plurality of times within the allowable number of transmissions, and the receiving node (14) checks the error detection codes of the received packets, and acquires data of the packets for which no errors are detected. Owing to this feature, redundancy of the communication data of the communications circuit (16) can be enhanced, the reliability of communications can be improved, and a delay in communications can be prevented.

In the above-described communications system (10), a plurality of the receiving nodes (14) may be provided, and the transmitting node (12) transmits, by the same communications circuit (16) and within the same period, different packets to the respective receiving nodes (14), and transmits the packets, which are to be transmitted to the respective receiving nodes (14), a plurality of times within the allowable number of transmissions. Owing to this feature, redundancy of the communication data of the communications circuit (16) can be enhanced, and the reliability of communications can be improved.

In the above-described communications system (10), the receiving node (14) may check the error detection codes of the received packets, and when an error is detected, may transmit an error detection signal to the transmitting node (12). When the transmitting node (12) receives the error detection signal transmitted by the receiving node (14), then in a following period and thereafter, the transmitting node (12) may transmit the same packets a plurality of times to the receiving node (14) that has transmitted the error detection signal. Owing to this feature, within the limited bandwidth of the communications circuit (16), it is possible to increase the number of transmissions of packets only when a code error occurs, congestion in the communications circuit (16) can be suppressed, and stability of communications of the communications circuit (16) can be enhanced.

In the above-described communications system (10), a plurality of the receiving nodes (14) may be provided, and the transmitting node (12) transmits, by the same communications circuit (16) and within the same period, different packets to the respective receiving nodes (14), and transmits the packets, which are to be transmitted to one of the receiving nodes (14) that has transmitted the error detection signal, a plurality of times within the allowable number of transmissions. Owing to this feature, it is possible to increase, within one period, the number of transmissions of packets for destinations which are likely to have code errors occurring therein, and the reliability of communications of the communications circuit (16) can be improved.

In the above-described communications system (10), the receiving node (14) may transmit an error prediction signal to the transmitting node if the magnitude of an amplitude of a received signal is less than or equal to a predetermined amplitude, if an amplitude of noise within the receiving node (14) is greater than or equal to a predetermined amplitude, if a temperature within the receiving node (14) is greater than or equal to a predetermined temperature, or if a vibration of the receiving node (14) is greater than or equal to a predetermined amplitude. When the transmitting node (12) receives the error prediction signal transmitted by the receiving node (14), then in a following period and thereafter, the transmitting node (12) may transmit the packets to be transmitted to the receiving node (14) a plurality of times. Owing to this feature, within the limited bandwidth of the communications circuit (16), it is possible to increase the number of transmissions of packets only when there is a concern of a code error occurring therein, congestion in the communications circuit (16) can be suppressed, and stability of communications of the communications circuit (16) can be enhanced.

In the above-described communications system (10), a plurality of the receiving nodes (14) may be provided, and the transmitting node (12) transmits, by the same communications circuit (16) and within the same period, different packets to the respective receiving nodes (14), and transmits the packets, which are to be transmitted to one of the receiving nodes (14) that has transmitted the error prediction signal, a plurality of times within the allowable number of transmissions. Owing to this feature, it is possible to increase, within one period, the number of transmissions of packets for destinations which are likely to have code errors occurring therein, and the reliability of communications of the communications circuit (16) can be improved.

What is claimed is:

1. A communications system including a transmitting node, and a receiving node connected by a communications circuit to the transmitting node, the communications system being configured to transmit packets from the transmitting node to the receiving node at each of predetermined periods, wherein:
each of the packets comprises at least data and an error detection code;
the transmitting node calculates an allowable number of transmissions at which the packets can be transmitted within the predetermined period, and transmits the same packets a plurality of times within the allowable number of transmissions; and
the receiving node checks the error detection codes of the received packets, and acquires data of the packets for which no errors are detected.

2. The communications system according to claim 1, wherein:
the receiving node comprises a plurality of receiving nodes; and
the transmitting node transmits, by the same communications circuit and within the same period, different packets to the respective receiving nodes, and transmits the packets, which are to be transmitted to the respective receiving nodes, a plurality of times within the allowable number of transmissions.

3. The communications system according to claim 1, wherein:
the receiving node checks the error detection codes of the received packets, and when an error is detected, transmits an error detection signal to the transmitting node; and
when the transmitting node receives the error detection signal transmitted by the receiving node, then in a following period and thereafter, the transmitting node transmits the same packets a plurality of times to the receiving node that has transmitted the error detection signal.

4. The communications system according to claim 3, wherein:
the receiving node comprises a plurality of receiving nodes; and
the transmitting node transmits, by the same communications circuit and within the same period, different packets to the respective receiving nodes, and transmits the packets, which are to be transmitted to one of the receiving nodes that has transmitted the error detection signal, a plurality of times within the allowable number of transmissions.

5. The communications system according to claim 1, wherein:
the receiving node transmits an error prediction signal to the transmitting node if a magnitude of an amplitude of a received signal is less than or equal to a predetermined amplitude, if an amplitude of noise within the receiving node is greater than or equal to a predetermined amplitude, if a temperature within the receiving node is greater than or equal to a predetermined temperature, or if a vibration of the receiving node is greater than or equal to a predetermined amplitude; and
when the transmitting node receives the error prediction signal transmitted by the receiving node, then in a following period and thereafter, the transmitting node transmits the packets to be transmitted to the receiving node a plurality of times.

6. The communications system according to claim 5, wherein:
the receiving node comprises a plurality of receiving nodes; and
the transmitting node transmits, by the same communications circuit and within the same period, different packets to the respective receiving nodes, and transmits the packets, which are to be transmitted to one of the receiving nodes that has transmitted the error prediction signal, a plurality of times within the allowable number of transmissions.

7. A communication method for a communications system including a transmitting node, and a receiving node connected by a communications circuit to the transmitting node, the communications system being configured to transmit packets from the transmitting node to the receiving node at each of predetermined periods, wherein each of the packets comprises at least data and an error detection code, the communication method comprising:
an allowable number of transmissions calculating step of calculating, in the transmitting node, an allowable number of transmissions at which the packets can be transmitted within the predetermined period;
a packet transmitting step of transmitting, in the transmitting node, the same packets a plurality of times within the allowable number of transmissions;
a packet receiving step of receiving, in the receiving node, the packets transmitted from the transmitting node;
an error detection code checking step of checking, in the receiving node, the error detection codes of the received packets; and
a data acquisition step of acquiring, in the receiving node, data of the packets for which no errors are detected.

8. The communication method for the communications system according to claim 7, wherein the receiving node comprises a plurality of receiving nodes; and
in the packet transmitting step, by the same communications circuit and within the same period, different packets are transmitted to the respective receiving nodes, and the packets, which are to be transmitted to the respective receiving nodes, are transmitted a plurality of times within the allowable number of transmissions.

9. The communication method for the communications system according to claim 7, further comprising:
an error detection signal transmitting step of checking, in the receiving node, the error detection codes of the received packets, and when an error is detected, transmitting an error detection signal to the transmitting node; and
an error detection signal receiving step of receiving, in the transmitting node, the error detection signal transmitted by the receiving node;
wherein, in the packet transmitting step, when the error detection signal transmitted by the receiving node is received in the error detection signal receiving step, then in a following period and thereafter, the same packets are transmitted a plurality of times to one of the receiving nodes that has transmitted the error detection signal.

10. The communication method for the communications system according to claim 9, wherein the receiving node comprises a plurality of receiving nodes;
wherein, in the packet transmitting step, by the same communications circuit and within the same period, different packets are transmitted to the respective receiving nodes, and the packets, which are to be transmitted to one of the receiving nodes that has transmitted the error detection signal, are transmitted a plurality of times within the allowable number of transmissions.

11. The communication method for the communications system according to claim 7, further comprising:
an error prediction signal transmitting step of transmitting, in the receiving node, an error prediction signal to the transmitting node, if a magnitude of an amplitude of a received signal is less than or equal to a predetermined amplitude, if an amplitude of noise within the receiving node is greater than or equal to a predetermined amplitude, if a temperature within the receiving node is greater than or equal to a predetermined temperature, or if a vibration of the receiving node is greater than or equal to a predetermined amplitude; and
an error prediction signal receiving step of receiving, in the transmitting node, the error prediction signal transmitted by the receiving node;
wherein, in the packet transmitting step, when the error prediction signal transmitted by the receiving node is received in the error prediction signal receiving step, then in a following period and thereafter, the packets to be transmitted to the receiving node are transmitted a plurality of times.

12. The communication method for the communications system according to claim 11, wherein the receiving node comprises a plurality of receiving nodes;
wherein, in the packet transmitting step, by the same communications circuit and within the same period, different packets are transmitted to the respective receiving nodes, and the packets, which are to be transmitted to one of the receiving nodes that has transmitted the error prediction signal, are transmitted a plurality of times within the allowable number of transmissions.
